(19) United States
(12) Patent Application Publication
(10) Pub. No.: US 2020/0140217 A1
(43) Pub. Date: May 7, 2020

(54) SHEET MANUFACTURING APPARATUS

(71) Applicant: SEIKO EPSON CORPORATION, Tokyo (JP)

(72) Inventors: Masanao FUKASAWA, Matsumoto-shi (JP); Yoshiyuki NAGAI, Shiojiri-shi (JP); Yuki OGUCHI, Okaya-shi (JP); Takayoshi YOGO, Matsumoto-shi (JP)

(73) Assignee: SEIKO EPSON CORPORATION, Tokyo (JP)

(21) Appl. No.: 16/672,634

(22) Filed: Nov. 4, 2019

(30) Foreign Application Priority Data
Nov. 5, 2018 (JP) 2018-208441

(51) Int. Cl. B65H 9/16; B65H 7/20; B65H 35/00; G01B 5/06

(52) U.S. Cl. CPC B65H 9/166; G01B 5/06; B65H 35/008; B65H 7/20

(57) ABSTRACT

A sheet manufacturing apparatus includes a transport section configured to transport a sheet made of a material containing fiber and a control section configured to control operation of the transport section. The transport section includes a first roller and a second roller which is disposed downstream of and separately from the first roller in a transport direction of the sheet and which is rotationally driven. The control section is configured to adjust a rotation speed of the second roller in accordance with a manufacturing condition of the sheet.

The present application is based on, and claims priority from JP Application Serial Number 2018-208441, filed Nov. 5, 2018, the disclosure of which is hereby incorporated by reference herein in its entirety.

### BACKGROUND

### 1. Technical Field

The present disclosure relates to a sheet manufacturing apparatus.

### 2. Related Art

Sheet manufacturing apparatuses have hitherto adopted wet methods for papermaking, in which a fiber-containing feedstock is placed in water and is then separated mainly by mechanical action, and made into paper. Such wet-method sheet manufacturing apparatuses require a large volume of water, resulting in a large size for such apparatuses. Moreover, not only is considerable effort required for the maintenance of water treatment equipment, but also a considerable amount of energy is expended in drying processes.

There are accordingly proposals for dry-method sheet manufacturing apparatuses in which the amount of water employed is kept to the minimum in order to reduce the size of apparatus and to reduce the energy consumed. For example, JP-A-9-1513 discloses an apparatus for manufacturing a sheet in which paper is defibrated with a dry method that does not use water, and a web is formed by dry-mixing recycled-paper pulp, which has been prepared so that the length-weighted average fiber length in the pulp is at least 0.5 mm, with polyolefin resin microfibers. The web is then heated and pressed as the web is being transported, and then cut to a predetermined length.

Paper is, for example, discharged by a sheet transport section employed to transport sheets prior to cutting and after cutting, and stacked in a stacker. The sheet transport section includes plural rotationally driven rollers. The web or the sheet makes contact with the rollers, and is transported by rotation of these rollers.

However, sometimes a variation from the desired speed arises in the transport speed due to the manufacturing conditions of a sheet. Depending on the degree by which the transport speed varies, the tension applied to a sheet may change, creases may appear in the sheet, and excessive load may be imparted to the sheet. As a result, sheet quality may deteriorate.

### SUMMARY

The present disclosure addresses the above issues, and may be realized in the following manner.

Accordingly to an aspect of the present disclosure, a sheet manufacturing apparatus includes a transport section configured to transport a sheet made of a material containing fiber and a control section configured to control operation of the transport section. The transport section includes a first roller and a second roller which is disposed downstream of and separately from the first roller in a transport direction of the sheet and which is rotationally driven. The control section is configured to adjust a rotation speed of the second roller in accordance with a manufacturing condition of the sheet.

### BRIEF DESCRIPTION OF THE DRAWINGS

FIG. 1 is a schematic side view illustrating the upstream of a sheet manufacturing apparatus of a first embodiment of the present disclosure.

FIG. 2 is a schematic side view illustrating the downstream of the sheet manufacturing apparatus of the first embodiment of the present disclosure.

FIG. 3 is a block diagram illustrating the sheet manufacturing apparatus illustrated in FIG. 1 and FIG. 2.

FIG. 4 is a flowchart to explain a control operation performed by a control section illustrated in FIG. 3.

FIG. 5 is a graph illustrating a calibration curve stored in a storage section provided to the control section illustrated in FIG. 3.

FIG. 6 is a schematic side view illustrating the downstream of a sheet manufacturing apparatus of a second embodiment of the present disclosure.

FIG. 7 is a flowchart to explain a control operation performed by a control section included in the sheet manufacturing apparatus illustrated in FIG. 6.

FIG. 8 is a graph illustrating a calibration curve stored in a storage section provided to the control section included in the sheet manufacturing apparatus illustrated in FIG. 6.

FIG. 9 is a flowchart to explain a control operation performed by a control section included in a sheet manufacturing apparatus of a third embodiment of the present disclosure.

FIG. 10 is a graph illustrating a calibration curve stored in a storage section provided to the control section included in the sheet manufacturing apparatus of the third embodiment of the present disclosure.

### DESCRIPTION OF EXEMPLARY EMBODIMENTS

A detailed explanation of a sheet manufacturing apparatus of the present disclosure is given below based on preferable embodiments as illustrated in the accompanying drawings.

### First Embodiment

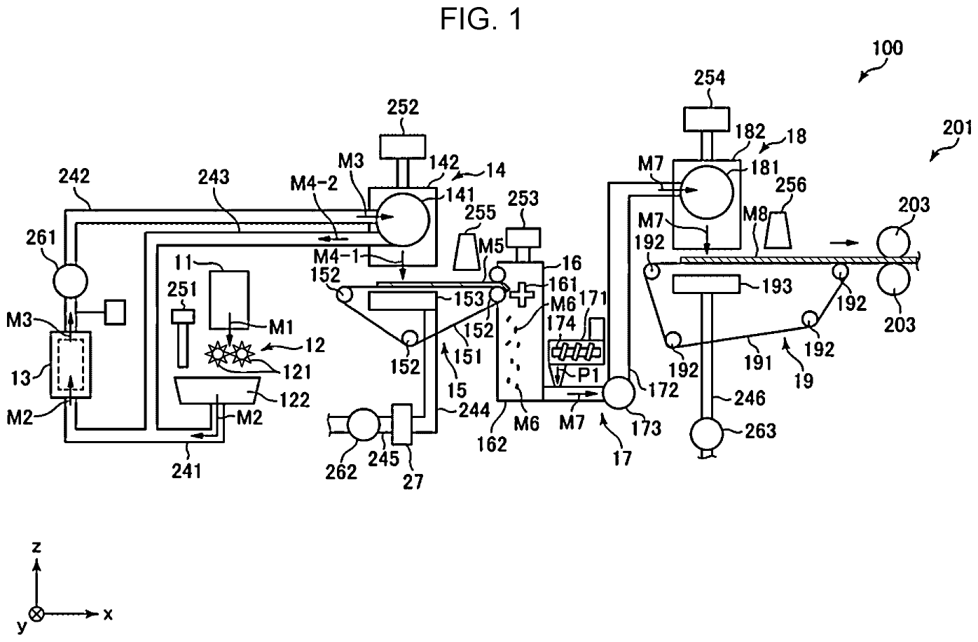

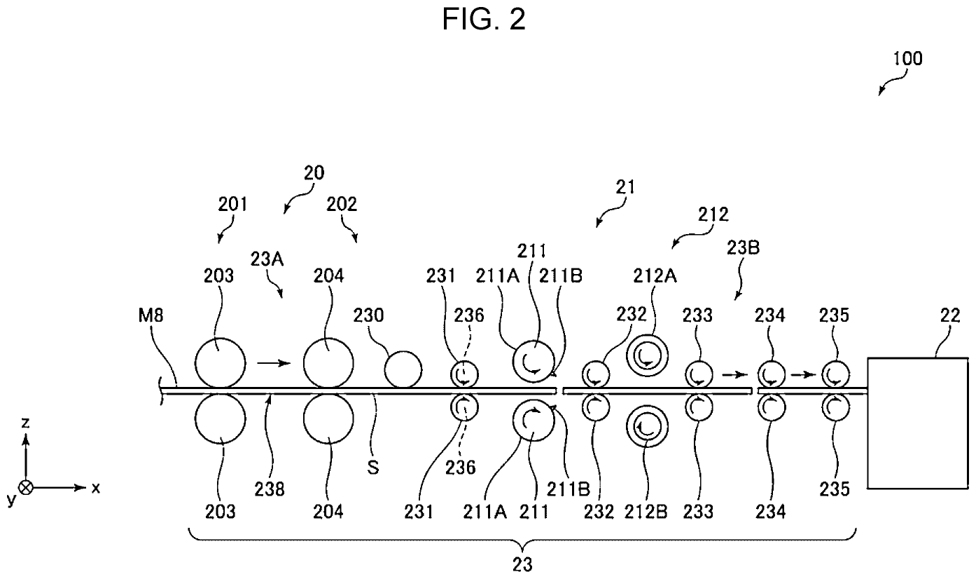

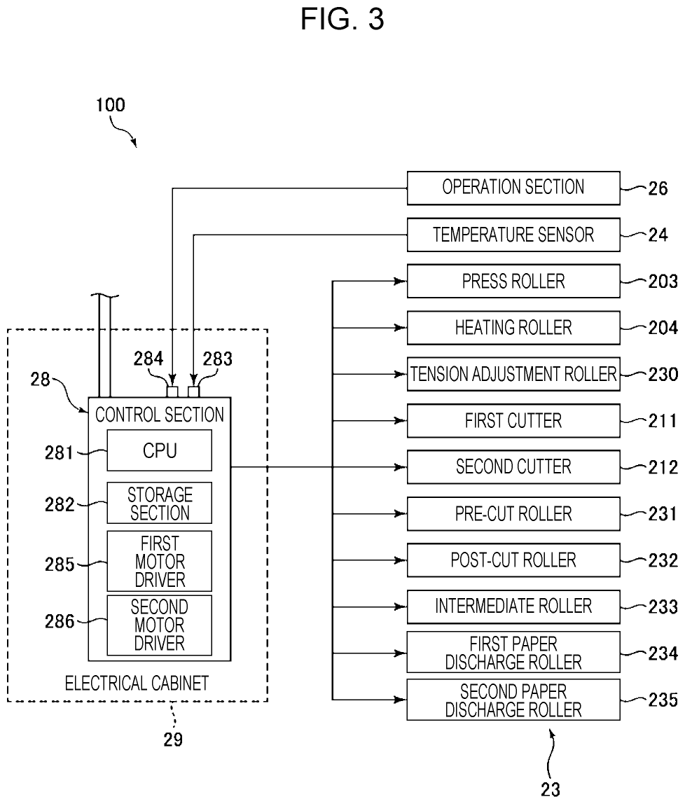

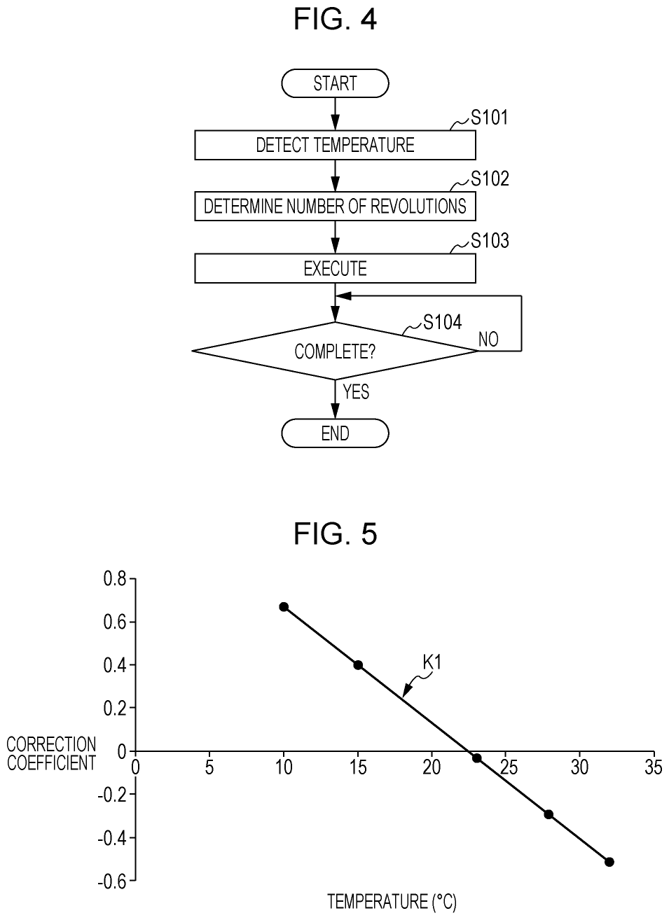

FIG. 1 is a schematic side view illustrating the upstream of a sheet manufacturing apparatus of a first embodiment of the present disclosure. FIG. 2 is a schematic side view illustrating the downstream of the sheet manufacturing apparatus of the first embodiment of the present disclosure. FIG. 3 is a block diagram illustrating the sheet manufacturing apparatus illustrated in FIG. 1 and FIG. 2. FIG. 4 is a flowchart to explain a control operation performed by a control section illustrated in FIG. 3. FIG. 5 is a graph illustrating a calibration curve stored in a storage section provided to the control section illustrated in FIG. 3.

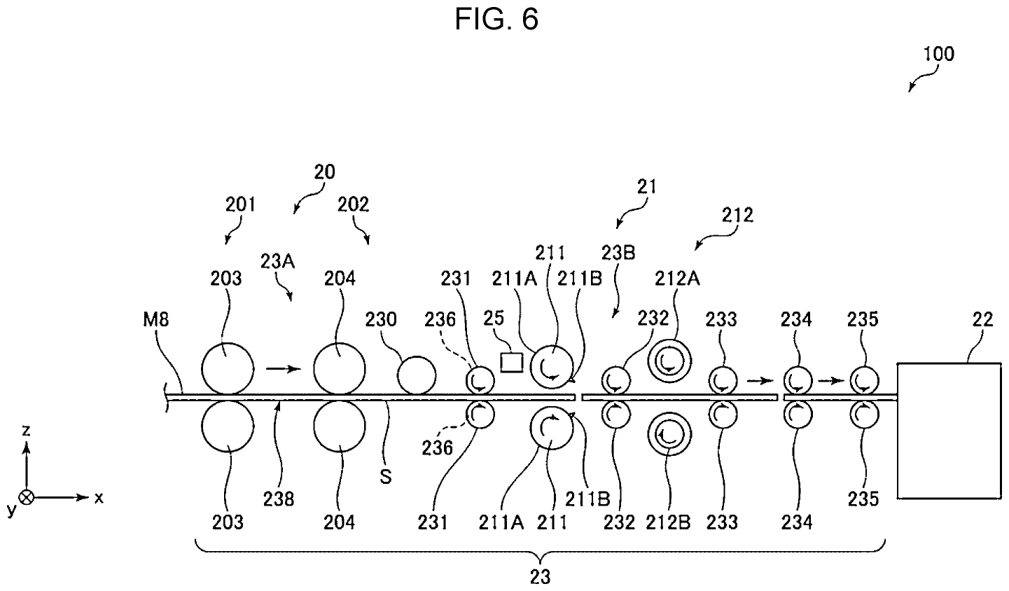

For ease of explanation, three mutually orthogonal axes illustrated in FIG. 1 and FIG. 2 will be referred to as an x-axis, a y-axis, and a z-axis. The xy-plane including the x-axis and the y-axis is horizontal, and the z-axis is vertical. The direction indicated by the arrow on each of the axes is referred to as “+”, and the opposite direction thereto is referred to as “−”. The top side of FIG. 1 and FIG. 2 is referred to as upper or upward, and the bottom side thereof is referred to as lower or downward. The left side of FIG. 1, FIG. 2, and FIG. 6 is referred to as being “upstream” and the right side thereof is referred to as being “downstream”.

As illustrated in FIG. 1 and FIG. 2, a sheet manufacturing apparatus 100 includes a feedstock supply section 11, a crushing section 12, a defibration section 13, a sorting section 14, a first web forming section 15, a shredding section 16, a mixer 17, a disentangling section 18, a second web forming section 19, a sheet forming section 20, a cutting section 21, a stacking section 22, a transport section 23, a temperature sensor 24, a collection section 27, and a control section 28. The transport section 23 transports a sheet S from upstream to downstream, and is installed at least between press rollers 203 and second paper discharge rollers 235 of a press section 201. Each of the sections configuring the sheet manufacturing apparatus 100 is electrically coupled to the control section 28 illustrated in FIG. 3, and the respective operations thereof are controlled by the control section 28.

As illustrated in FIG. 1 and FIG. 2, the sheet manufacturing apparatus 100 also includes a humidifier 251, a humidifier 252, a humidifier 253, a humidifier 254, a humidifier 255, and a humidifier 256. The sheet manufacturing apparatus 100 also includes a blower 173, a blower 261, a blower 262, and a blower 263.

The sheet manufacturing apparatus 100 executes the following processes in sequence: a feedstock supply process, a crushing process, a defibration process, a sorting process, a first web forming process, a dividing process, a mixing process, a disentangling process, a second web forming process, a sheet forming process, and a cutting process.

Explanation follows regarding the configuration of each of these sections.

As illustrated in FIG. 1, the feedstock supply section 11 is the section where the feedstock supply process is performed, in which a feedstock M1 is supplied into the crushing section 12. Examples of the feedstock M1 include sheet-form materials made from fiber-containing materials that include cellulose fibers. Cellulose fibers are any material formed into a fibrous shape that has cellulose as the main component compound thereof, and may be a material including hemicellulose and lignin in addition to cellulose. The form of the feedstock M1 is not important and may be woven, non-woven, or the like. The feedstock M1 may, for example, be recycled-paper manufactured by defibrating and reusing old paper, and synthetic paper such as YUPO paper (registered trademark). The feedstock M1 is not necessarily recycled paper. The feedstock M1 in the present embodiment is old paper that may be either previously used or scrap.

The crushing section 12 is the section where the crushing process is performed, in which the feedstock M1 supplied from the feedstock supply section 11 is crushed in air, such as in atmospheric air. The crushing section 12 includes a pair of crushing blades 121, and a chute 122.

The pair of crushing blades 121 rotate in opposite directions to each other so as to crush the feedstock M1 between the blades, i.e. so as to cut the feedstock M1 into coarse fragments M2. The shape and size of the coarse fragments M2 are preferably tailored to the defibration process in the defibration section 13 and are, for example, preferably small fragments with a side length of not more than 100 mm, and more preferably small fragments with a side length from 10 mm to 70 mm.

The chute 122 is disposed below the pair of crushing blades 121 and is, for example, configured with a funnel shape. The chute 122 is thereby able to receive falling coarse fragments M2 that have been crushed by the crushing blades 121.

The humidifier 251 is disposed above the chute 122 and alongside the pair of crushing blades 121. The humidifier 251 humidifies the coarse fragments M2 inside the chute 122. The humidifier 251 is configured by a vaporizing humidifier, particularly by a warm air vaporizing humidifier, that includes a moist non-illustrated filter and that feeds humidified air of raised humidity into the coarse fragments M2 by passing air through the filter. Feeding the humidified air into the coarse fragments M2 enables the coarse fragments M2 to be inhibited from adhering with static electricity to the chute 122 or the like.

The chute 122 is coupled to the defibration section 13 by a pipe 241. The coarse fragments M2 collected in the chute 122 are transported through the pipe 241 to the defibration section 13.

The defibration section 13 is the section that performs the defibration process on the coarse fragments M2 in air, namely performs dry defibration. A defibrated material M3 can be generated from the coarse fragments M2 by performing the defibration process in the defibration section 13. “Defibration” as referred to here means taking the coarse fragments M2 configured from plural fibers bound together, and disentangling the fibers into individual fibers. The disentangled product is referred to as the defibrated material M3. The defibrated material M3 may be in the form of lines or strips. There may still be defibrated material M3 present that is intertwined in agglomerations, that is, formed into what is referred to as “clumps”.

The defibration section 13 of the present embodiment is, for example, configured by an impeller mill including a high speed rotor and a liner positioned around the outer periphery of the rotor. The coarse fragments M2 flowing into the defibration section 13 are squeezed between the rotor and the liner and defibrated thereby.

The defibration section 13 is able to generate a flow of air, i.e. an airflow, from the crushing section 12 toward the sorting section 14 by rotation of the rotor. This enables the coarse fragments M2 to be sucked into the defibration section 13 through the pipe 241. After the defibration process, the defibrated material M3 can then be sent on toward the sorting section 14 through a pipe 242.

The blower 261 is installed partway along the pipe 242. The blower 261 is an airflow generating device for generating an airflow toward the sorting section 14. This promotes transportation of the defibrated material M3 toward the sorting section 14.

The sorting section 14 is the section where the sorting process is performed, in which the defibrated material M3 is sorted into long and short fibers. The defibrated material M3 is sorted in the sorting section 14 into a first sorted material M4-1, and a second sorted material M4-2 larger than the first sorted material M4-1. The first sorted material M4-1 is for fibers of a length suitable for manufacturing a sheet S at a later stage. The average length in the first sorted material M4-1 is preferably from 1 μm to 30 μm. The second sorted material M4-2 includes, for example, insufficiently defibrated fibers, defibrated fibers that have aggregated together excessively, etc.

The sorting section 14 includes a drum 141, and a housing 142 housing the drum 141.

The drum 141 is configured by a cylindrical mesh, and is a sieve that rotates about its own central axis. The defibrated material M3 flows into the drum 141. Rotation of the drum 141 sorts defibrated material M3 smaller than the size of the mesh into the first sorted material M4-1, and sorts defibrated material M3 larger than the mesh size into the second sorted material M4-2.

The first sorted material M4-1 falls through the drum 141. However, the second sorted material M4-2 is fed out into a pipe 243 coupled to the drum 141. The opposite end of the pipe 243 to the drum 141 is coupled to the pipe 241 at the upstream thereof. The second sorted material M4-2 that has passed through the pipe 243 merges with the coarse fragments M2 inside the pipe 241, and flows back into the defibration section 13 together with the coarse fragments M2. The second sorted material M4-2 is thereby returned to the defibration section 13, and is subjected to defibration processing together with the coarse fragments M2.

The first sorted material M4-1 from the drum 141 falls while being dispersed in the air, and falls toward the first web forming section 15 positioned below the drum 141. The first web forming section 15 is the section where the first web forming process is performed, in which a first web M5 is formed from the first sorted material M4-1. The first web forming section 15 includes a mesh belt 151, three tension rollers 152, and a suction section 153.

The mesh belt 151 is an endless belt for the first sorted material M4-1 to accumulate thereon. The mesh belt 151 is entrained around the three tension rollers 152. The first sorted material M4-1 lying on the mesh belt 151 is transported downstream by rotational driving of the tension rollers 152.

The first sorted material M4-1 is made of fibers larger than the mesh size of the mesh belt 151. The first sorted material M4-1 is thereby restricted from passing through the mesh belt 151, and can accordingly be accumulated on the mesh belt 151. The first sorted material M4-1 is formed into a layer as the first web M5 by accumulating on the mesh belt 151 while being transported downstream along with the mesh belt 151.

There is a concern that there might, for example, be dirt and dust etc. mixed in with the first sorted material M4-1. The dirt and dust is, for example, generated by the crushing and defibration. Such dirt and dust is collected in the collection section 27, described later.

The suction section 153 is a suction mechanism that suctions air downwards from the mesh belt 151. The dirt and dust that has passed through the mesh belt 151 can thereby be suctioned along with the air.

The suction section 153 is coupled through a pipe 244 to the collection section 27. The dirt and dust suctioned by the suction section 153 is collected in the collection section 27.

A pipe 245 is also coupled to the collection section 27. A blower 262 is installed partway along the pipe 245. This enables a suction force to be generated at the suction section 153 by operation of the blower 262. The formation of the first web M5 on the mesh belt 151 is promoted thereby. The first web M5 has had the dirt and dust etc. removed therefrom. The dirt and dust passes through the pipe 244 and is delivered to the collection section 27 by operation of the blower 262.

The housing 142 is coupled to the humidifier 252. The humidifier 252 is configured by a vaporizing humidifier similar to the humidifier 251. Humidified air is thereby fed into the housing 142. The first sorted material M4-1 can be humidified by the humidified air, enabling the first sorted material M4-1 to be inhibited from adhering with static electricity to the inside walls of the housing 142.

The humidifier 255 is disposed downstream of the sorting section 14. The humidifier 255 is configured by an ultrasonic humidifier that creates a mist of water. This enables moisture to be supplied to the first web M5, thereby adjusting the moisture content of the first web M5. Such adjustment enables the first web M5 to be inhibited from adhering with static electricity to the mesh belt 151. The first web M5 is thereby readily separated from the mesh belt 151 at the position where the mesh belt 151 returns on itself around one of the tension rollers 152.

The shredding section 16 is disposed downstream of the humidifier 255. The shredding section 16 is the section where the dividing process is performed, in which the first web M5 that has separated from the mesh belt 151 is divided. The shredding section 16 includes a rotatably supported propeller 161 and a housing 162 housing the propeller 161. The first web M5 can be divided by the rotating propeller 161. The first web M5 when divided becomes shreddings M6. The shreddings M6 fall inside the housing 162.

The housing 162 is coupled to the humidifier 253. The humidifier 253 is configured by a vaporizing humidifier similar to the humidifier 251. Humidified air is thereby fed into the housing 162. The humidified air enables the shreddings M6 to be inhibited from adhering with static electricity to the propeller 161 and the inside walls of the housing 162.

The mixer 17 is disposed downstream of the shredding section 16. The mixer 17 is the section where the mixing process is performed, in which the shreddings M6 and a resin P1 are mixed together. The mixer 17 includes a resin feeder 171, a pipe 172, and the blower 173.

The pipe 172 couples the housing 162 of the shredding section 16 and a housing 182 of the disentangling section 18 together, and is a flow path for a mixed material M7, a mixture of the shreddings M6 and the resin P1, to pass through.

The resin feeder 171 is coupled partway along the pipe 172. The resin feeder 171 includes a screw feeder 174. The resin P1 can be fed into the pipe 172 as a powder or as granules by rotational driving of the screw feeder 174. The resin P1 fed into the pipe 172 is mixed with the shreddings M6 to form the mixed material M7.

Note that the resin P1 is employed to bind fibers together in a later process and although it may, for example, be a thermoplastic resin or curable resin, a thermoplastic resin is preferably employed therefor. Examples of such thermoplastic resins include: AS resins; ABS resins; polyolefins and modified polyolefins such as such as polyethylene, polypropylene, ethylene-vinyl acetate copolymer (EVA) and the like; acrylic resins such as poly (methyl methacrylate); polyesters such as poly vinyl chloride, polystyrene, polyethylene terephthalate, polybutylene terephthalate and the like; polyamides such as NYLON 6, NYLON 46, NYLON 66, NYLON 610, NYLON 612, NYLON 11, NYLON 12, NYLON 6-12, NYLON 6-66 and the like; polyphenylene ethers; polyacetals; polyethers; polyphenylene oxides; polyether ether ketones; polycarbonates; polyphenylene sulfides; thermoplastic polyimides; polyether imides; liquid crystal polymers such as aromatic polyesters; and various types of thermoplastic elastomer such as styrene-based, polyolefin-based, polyvinyl chloride-based, polyurethane-based, polyester-based, polyamide-based, polybutadiene-based, transpolyisoprene-based, fluorine rubber-based, or chlorinated polyethylene-based thermoplastic elastomers. One resin selected from the above resins may be employed as the thermoplastic resin alone, or two or more resins selected therefrom may be employed in combination. A polyester resin or a resin including polyester is preferably employed as the thermoplastic resin.

In addition to the resin P1, other substances may also be fed out from the resin feeder 171. These include a colorant to color the fibers, an anti-caking agent to inhibit aggregation of the fibers and aggregation of the resin P1, a fire retardant to render the fibers etc. less liable to combust, and a paper strengthening agent to increase the paper strength of the sheet S. Alternatively these other substances may be compounded with the resin P1 in advance before then being fed out from the resin feeder 171.

The blower 173 is installed partway along the pipe 172 at a position downstream of the resin feeder 171. The shreddings M6 and the resin P1 are mixed together by the action of a rotating section such as fan blades of the blower 173. The blower 173 is capable of generating an airflow toward the disentangling section 18. The shreddings M6 and the resin P1 can be stirred inside the pipe 172 by this airflow. The mixed material M7 can be introduced into the disentangling section 18 in a state in which the shreddings M6 and the resin P1 have been uniformly dispersed. The shreddings M6 in the mixed material M7 are disentangled up by the process of passing through the inside of the pipe 172 so as to result in a finer fibrous form.

The disentangling section 18 is the section where the disentangling process is performed to disentangle the intertwined fibers in the mixed material M7 from each other. The disentangling section 18 includes a drum 181 and a housing 182 housing the drum 181.

The drum 181 is a configured by a cylindrical mesh, and is a sieve that rotates about its own central axis. The mixed material M7 flows into the drum 181. Rotation of the drum 181 enables the fibers and the like in mixed material M7 smaller than the size of the mesh to pass through the drum 181. The mixed material M7 is disentangled by this action.

The housing 182 is coupled to the humidifier 254. The humidifier 254 is configured by a vaporizing humidifier similar to the humidifier 251. Humidified air is thereby fed into the housing 182. The inside of the housing 182 can be humidified by the humidified air, enabling the mixed material M7 to be inhibited from adhering with static electricity to the inside walls of the housing 182.

The mixed material M7 disentangled by the drum 181 is dispersed in the air while falling toward the second web forming section 19 positioned below the drum 181. The second web forming section 19 is the section where the second web forming process is performed to form a second web M8 from the mixed material M7. The second web forming section 19 includes a mesh belt 191, tension rollers 192, and a suction section 193.

The mesh belt 191 is an endless belt for the mixed material M7 to accumulate on. The mesh belt 191 is entrained around the four tension rollers 192. The mixed material M7 on the mesh belt 191 is transported downstream by rotational driving of the tension rollers 192.

Almost all of the mixed material M7 on the mesh belt 191 is the size of the mesh of the mesh belt 191 or larger. This enables the mixed material M7 to be restricted from passing through the mesh belt 191, and enables the mixed material M7 to be accumulated on the mesh belt 191. The mixed material M7 is formed into a layer as the second web M8 by accumulating on the mesh belt 191 while being transported downstream along with the mesh belt 191.

The suction section 193 is a suction mechanism that suctions air downwards from the mesh belt 191. This enables the mixed material M7 on the mesh belt 191 to be suctioned, thereby promoting accumulation of the mixed material M7 on the mesh belt 191.

A pipe 246 is coupled to the suction section 193. The blower 263 is installed partway along the pipe 246. A suction force can be generated at the suction section 193 by operation of the blower 263.

The humidifier 256 is disposed downstream of the disentangling section 18. The humidifier 256 is configured by an ultrasonic humidifier similar to the humidifier 255. This enables moisture to be supplied to the second web M8, thereby adjusting the moisture content of the second web M8. Such adjustment enables the second web M8 to be inhibited from adhering with static electricity to the mesh belt 191. The second web M8 is thereby readily separated from the mesh belt 191 at the position where the mesh belt 191 is returns on itself around one of the tension rollers 192.

The total moisture content added by the humidifier 251 to the humidifier 256 is, for example, preferably from 0.5 parts by weight to 20 parts by weight with respect to 100 parts by weight of material prior to humidification.

The sheet forming section 20 is disposed downstream of the second web forming section 19, as illustrated in FIG. 2. The sheet forming section 20 is the section where the sheet forming process is performed to form the sheet S from the second web M8. The sheet forming section 20 includes the press section 201 and a heating section 202.

The press section 201 includes a pair of press rollers 203 to enable the second web M8 to be pressed between the press rollers 203 without being heated. The density of the second web M8 is raised thereby. The level of heating at this point is, for example, preferably a level of heating that will not melt the resin P1. The second web M8 is then transported toward the heating section 202. One of the pair of press rollers 203 is a lead roller driven by operation of a non-illustrated motor, and the other is a following roller.

The heating section 202 includes a pair of heating rollers 204 to enable the second web M8 to be pressed between the heating rollers 204 while being heated. The resin P1 is melted by the heating and pressing, and the fibers in the second web M8 are bonded together by the molten resin P1. The sheet S is formed thereby. The sheet S is then transported toward the cutting section 21. Note that one of the pair of heating rollers 204 is a lead roller driven by operation of a non-illustrated motor, and the other is a following roller.

A forming roller set is configured by the press section 201 and the heating section 202 to form the web including a material containing fiber.

The cutting section 21 is disposed downstream of the sheet forming section 20. The cutting section 21 is the section where the cutting process is performed to cut the sheet S. The cutting section 21 includes first cutters 211, and second cutters 212 installed downstream of the first cutters 211.

The first cutters 211 cut the sheet S along a direction intersecting with the transport direction of the sheet S, and in particular a direction orthogonal thereto. The first cutters 211 include a pair of rollers 211A and knives 211B. The rollers 211A are installed so as to be separated from each other along a thickness direction of the transported sheet S, i.e. separated in a z axis direction, and the knives 211B are each mounted so as to protrude from peripheral portions of the respective rollers 211A. The knives 211B are mounted along the axial directions of the respective rollers 211A.

The first cutters 211 are electrically coupled to the control section 28, as illustrated in FIG. 3, and operation of the first cutters 211 is controlled by the control section 28. The first cutters 211 rotate in the directions illustrated by the arrows in FIG. 2, and when doing so the knives 211B make contact with each other. The passing sheet S is cut thereby. The x axis direction length of the sheet S is adjustable by adjusting the rotation speed of the first cutters 211.

The second cutters 212 slit the sheet S in a direction parallel to the transport direction of the sheet S at a position downstream of the first cutters 211. The second cutters 212 are configured by a total of four circular disk shaped rotating knives 212A and rotating knives 212B. The rotating knives 212A and the rotating knives 212B are arranged so as to face each other across the sheet S as it is being transported, namely to face each other across a transport path 238. This enables the transported sheet S to be slit by contact between the rotating knives 212A and the rotating knives 212B.

The rotating knives 212A and rotating knives 212B are arranged in pairs that are arranged along the width direction of the sheet S, i.e. along the y axis direction. This enables removal of the two end portions of the sheet S, i.e. unwanted portions at end portions in the +y axis direction and the −y axis direction, so as to fix the width of the sheet S. The portions removed by this slitting are called “offcuts”.

The distance between the pairs of rotating knives 212A and rotating knives 212B in the second cutters 212 is adjustable in the y axis direction. This enables the length of the sheet S to be adjusted in the y axis direction by adjusting this distance.

A sheet S of the desired shape and size is obtained by this cutting by the first cutters 211 and the second cutters 212. Each sheet S is then transported further downstream and stacked in the stacking section 22.

The transport section 23 includes a function to transport the sheet S, which has been formed by the press section 201 and the heating section 202, to the stacking section 22. The transport section 23 includes a tension adjustment roller 230 that contacts the top face of the sheet S and rotates, pre-cut rollers 231, post-cut rollers 232, intermediate rollers 233, first paper discharge rollers 234, and the second paper discharge rollers 235. The pre-cut rollers 231, the post-cut rollers 232, the intermediate rollers 233, the first paper discharge rollers 234, and the second paper discharge rollers 235 are arranged in this sequence from the sheet S transport direction upstream, i.e. from the −x axis side.

The pre-cut rollers 231, the post-cut rollers 232, the intermediate rollers 233, the first paper discharge rollers 234, and the second paper discharge rollers 235 are also arranged as pairs on each side of the transport path 238.

Since the transport section 23 in the present specification refers to any section contributing to transportation of the sheet S, the transport section 23 also includes the press rollers 203 and the heating rollers 204 in addition to each of the rollers described above. Namely, the press rollers 203 and the heating rollers 204 may also be said to transport the sheet S downstream while forming the sheet S.

The press rollers 203, the heating rollers 204, and the tension adjustment roller 230 correspond to a first roller 23A. The pre-cut rollers 231, the post-cut rollers 232, the intermediate rollers 233, the first paper discharge rollers 234, and the second paper discharge rollers 235 correspond to a second roller 23B.

The tension adjustment roller 230 has functionality to adjust the tension applied to the sheet S. The tension adjustment roller 230 is installed between the heating rollers 204 and the first cutters 211, and at the top face side of the transported sheet S, i.e. on the +z-axis side. The tension adjustment roller 230 is configured to employ its own weight to apply load to the sheet S being transported. Non-illustrated contact sensors are disposed above the tension adjustment roller 230 and below the tension adjustment roller 230 on the other side of the sheet S. This enables the tension on the sheet S to be adjusted when the sheet S contacts either of the contact sensors by, for example, adjusting the rotation speed of the pre-cut rollers 231.

The pre-cut rollers 231 are arranged as a pair between the tension adjustment roller 230 and the first cutters 211, at positions on each side of the transport path 238 in the z axis direction. The pre-cut rollers 231 contribute in particular to transportation of the sheet S prior to cutting by the first cutters 211, until the sheet S is cut by the first cutters 211. The sheet S prior to cutting can be transported in the +x axis direction by each of the pre-cut rollers 231 rotating in the direction of the arrows in FIG. 2 while the sheet S is in a pinched state between the pre-cut rollers 231.

One of the pair of pre-cut rollers 231 is a lead roller driven by operation of a non-illustrated motor, and the other is a following roller. As illustrated in FIG. 3, the lead roller of the pre-cut rollers 231 is electrically coupled to the control section 28, and operation thereof is controlled by the control section 28.

The post-cut rollers 232 are arranged as a pair between the first cutters 211 and the second cutters 212, on each side of the transport path 238 in the z axis direction. The post-cut rollers 232 contribute in particular to transportation of the sheet S from prior to cutting, through cutting by the first cutters 211, and until the sheet S is passed to the intermediate rollers 233. The sheet S after cutting can be transported in the +x axis direction by each of the post-cut rollers 232 rotating in the direction of the arrows in FIG. 2 while the sheet S is in a pinched state between the post-cut rollers 232.

One of the pair of post-cut rollers 232 is a lead roller driven by operation of a non-illustrated motor, and the other is a following roller. As illustrated in FIG. 3, the lead roller of the post-cut rollers 232 is electrically coupled to the control section 28 and operation thereof is controlled by the control section 28.

The intermediate rollers 233 are arranged as a pair downstream of the second cutter 212, i.e. on the +x axis side, at positions on each side of the transport path 238 in the z axis direction. The intermediate rollers 233 contribute in particular to transportation of the sheet S after the “offcuts” have been cut off. The sheet S from which the “offcuts” have been cut can be transported in the +x axis direction by each of the intermediate rollers 233 rotating in the direction of the arrows in FIG. 2 while the sheet S is in a pinched state between the intermediate rollers 233.

One of the pair of intermediate rollers 233 is a lead roller driven by operation of a non-illustrated motor, and the other is a following roller. As illustrated in FIG. 3, the lead roller of the intermediate rollers 233 is electrically coupled to the control section 28 and operation thereof is controlled by the control section 28.

The first paper discharge rollers 234 are arranged as a pair downstream of the intermediate rollers 233, i.e. at the +x axis side, at positions on each side of the transport path 238 in the z axis direction. The first paper discharge rollers 234 contribute in particular to transportation of the sheet S up to the stacking section 22. The sheet S can be transported in the +x axis direction by each of the first paper discharge rollers 234 rotating in the direction of the arrows in FIG. 2 while the sheet S is in a pinched state between the first paper discharge rollers 234.

One of the pair of first paper discharge rollers 234 is a lead roller driven by operation of a non-illustrated motor, and the other is a following roller. As illustrated in FIG. 3, the lead roller of the first paper discharge rollers 234 is electrically coupled to the control section 28 and operation thereof is controlled by the control section 28.

The second paper discharge rollers 235 are arranged as a pair downstream of the first paper discharge rollers 234, i.e. at the +x axis side, at positions on each side of the transport path 238 in the z axis direction. The second paper discharge rollers 235 contribute in particular to transportation of the sheet S up to the stacking section 22. The sheet S can be transported to the stacking section 22 by each of the second paper discharge rollers 235 rotating in the direction of the arrows in FIG. 2 while the sheet S is in a pinched state between the second paper discharge rollers 235.

One of the pair of second paper discharge rollers 235 is a lead roller driven by operation of a non-illustrated motor, and the other is a following roller. As illustrated in FIG. 3, the lead roller of the second paper discharge rollers 235 is electrically coupled to the control section 28 and operation thereof is controlled by the control section 28.

The rotation speeds of the rollers are adjusted as appropriate for the pre-cut rollers 231, the post-cut rollers 232, the intermediate rollers 233, the first paper discharge rollers 234, and the second paper discharge rollers 235.

The temperature sensor 24 has functionality to detect the temperature of the atmosphere in the vicinity of an electrical cabinet 29 housing the control section 28, as illustrated in FIG. 3. The temperature sensor 24 is electrically coupled to the control section 28, and information related to the detected temperature is converted into an electrical signal by the temperature sensor 24 for input to an input terminal 283 serving as an input section of the control section 28.

An input voltage, output voltage, reference voltage and the like of a first motor driver 285 and a second motor driver 286, described later, fluctuate with temperature. A configuration is accordingly adopted so as to enable the temperature characteristics of the first motor driver 285 and the second motor driver 286 to be cancelled out by detecting the temperature of the electrical cabinet 29, namely the temperature of at least one out of the first motor driver 285 or the second motor driver 286, and then performing correction based thereon.

The temperature sensor 24 may be disposed, in the transport direction, downstream of the press rollers 203, the heating rollers 204, and the tension adjustment roller 230 each of which is the first roller 23A, so as to detect the temperature downstream of the first roller 23A. Namely, one of the sheet S manufacturing conditions is the temperature downstream of the first roller 23A, and the control section 28 may adjust the transport speed based on this temperature. This enables the temperature of the atmosphere around the second roller 23B to be detected accurately more directly, so as to enable more accurate adjustment of the transport speed of the sheet S.

Note that the temperature sensor 24 is not limited to being installed at the position described above, and may be installed at a freely chosen position such as, for example, at the outside of cladding around the sheet manufacturing apparatus 100.

An operation section 26 illustrated in FIG. 3 is employed by an operator to perform various settings. The operation section 26 may, for example, be a touch-panel monitor including an input screen. The operation section 26 is electrically coupled to the control section 28, and information set by the operator using the operation section 26 is input to an input terminal 284 serving as an input section of the control section 28.

The operation section 26 is not limited to being a touch-panel monitor, and may be configured by a separately installed monitor and buttons, or by buttons alone.

As illustrated in FIG. 3, the control section 28 includes a central processing unit (CPU) 281, a storage section 282, a first motor driver 285, and a second motor driver 286. The CPU 281 may, for example, perform various determination and issue various commands and the like.

The storage section 282 is, for example, stored with various programs, such as a program for manufacturing the sheet S, and is stored with a calibration curve K1, a calibration curve K2, and a calibration curve K3 etc., as described later.

The first motor driver 285 has functionality to drive the first roller 23A described above. The second motor driver 286 has functionality to drive the second roller 23B described above.

The control section 28 may be built into the sheet manufacturing apparatus 100, or may be provided as a peripheral device such as an external computer or the like. Examples of such a peripheral device include, for example, cases in which the peripheral device is in communication with the sheet manufacturing apparatus 100 through a cable or the like, wireless communication cases, and cases in which the peripheral device is coupled to the sheet manufacturing apparatus 100 over a network such as the Internet.

The CPU 281 and the storage section 282 may, for example, be integrated together into a single unit, or the CPU 281 may be built into the sheet manufacturing apparatus 100 and the storage section 282 provided as a peripheral device such as an external computer or the like. Alternatively the storage section 282 may be built into the sheet manufacturing apparatus 100 and the CPU 281 provided as a peripheral device such as an external computer or the like.

In the transport section 23 the proportional contribution to the transportation of the sheet S is comparatively high for the pre-cut rollers 231, the post-cut rollers 232, the intermediate rollers 233, and the first paper discharge rollers 234 in particular. Maintaining the transport speed as close as possible to the desired speed using these rollers enables tension that is neither excessive nor insufficient to be applied to the sheet S being transported. As a result, the generation of creases in the sheet S due to slack, and a reduction in strength due to excessive tension, can both be prevented, enabling the quality of the sheet S to be raised.

The motors driving each of the rollers in the transport section 23 sometimes have temperature characteristics in which the actual number of revolutions thereof differs from the a desired number of revolutions as a result of fluctuations in the ambient temperature. Particularly in such cases, such temperature characteristics tend to be more pronounced when the motors driving each of the rollers in the transport section 23 are configured by DC motors. For example, the resistance values of a coil and the magnetic force of a magnet change in accordance with the ambient temperature, causing the number of revolutions of the motors to fluctuate as a result.

Thus in the present embodiment, the rotation speed of the rollers is adjusted for the pre-cut rollers 231, the post-cut rollers 232, the intermediate rollers 233, the first paper discharge rollers 234, and the second paper discharge rollers 235 in accordance with the temperature of the atmosphere in which these rollers are installed. Namely, the present embodiment is configured such that the transport speed of the sheet S is corrected by adjusting the rotation speed of the rollers to an appropriate value, thereby preventing a reduction in the quality of the sheet S. In the following explanation a representative example of correction of the pre-cut rollers 231 will be explained, since adjustment of the rotation speed of the pre-cut rollers 231, the post-cut rollers 232, the intermediate rollers 233, the first paper discharge rollers 234, and the second paper discharge rollers 235 is substantially the same in each case.

As illustrated in FIG. 5, the calibration curve K1 is pre-stored in the storage section 282. The calibration curve K1 is obtained by experimentation as a plot of the temperature of the atmosphere around the pre-cut rollers 231 against the most appropriate correction coefficients corresponding thereto. Note that these correction coefficients are coefficients employed to correct the number of revolutions, and are values derived by taking the most appropriate number of revolutions of the pre-cut rollers 231 for the temperature of the atmosphere around the pre-cut rollers 231 as obtained by experimentation, dividing the most appropriate number of revolutions by the number of revolutions initially set, and subtracting 1 from the result.

The number of revolutions initially set is a value in a range from 1 rpm to 100 rpm.

Each of the rollers in the transport section 23 has a different number of revolutions initially set. The number of revolutions initially set is set in the present embodiment such that the peripheral speed of the rollers is faster further downstream in order of the press rollers 203, the heating rollers 204, the pre-cut rollers 231, the post-cut rollers 232, the intermediate rollers 233, the first paper discharge rollers 234, and the second paper discharge rollers 235. This enables transportation to be performed while applying an appropriate tension to the sheet S. The most appropriate numbers of revolutions of the press rollers 203, the heating rollers 204, the pre-cut rollers 231, the post-cut rollers 232, the intermediate rollers 233, the first paper discharge rollers 234, and the second paper discharge rollers 235 also have such a relationship after being corrected. Namely, after adjustment, the rollers each of which is the second roller 23B have a peripheral speed of a value greater than a value of the peripheral speed of the first roller 23A. This thereby enables transportation to be performed while applying an appropriate tension to the sheet S.

The control section 28 takes the temperature detected by the temperature sensor 24 as the temperature of the atmosphere around the pre-cut rollers 231, and finds the correction coefficient corresponding to this temperature using the calibration curve K1. Then a value obtained by adding 1 to the correction coefficient is multiplied by the number of revolutions initially set to compute the most appropriate number of revolutions for the temperature of the atmosphere around the pre-cut rollers 231. The control section 28 then outputs a command to the pre-cut rollers 231 to operate at this most appropriate number of revolutions, thereby enabling the pre-cut rollers 231 to transport the sheet S at the most appropriate number of revolutions according to the ambient temperature.

For example, as illustrated in FIG. 5, when the ambient temperature is 23° C., the temperature is at the ideal temperature and so the correction coefficient is zero. Operation is accordingly performed at the number of revolutions initially set. Moreover, since the correction coefficient is 0.4 when the ambient temperature is 15° C., the most appropriate number of revolutions is the value obtained by multiplying the number of revolutions initially set by 1.04, and operation is performed at this most appropriate number of revolutions.

Such control is also performed on the post-cut rollers 232, the intermediate rollers 233, the first paper discharge rollers 234, and the second paper discharge rollers 235, such that the sheet S is transported to the stacking section 22 while being maintained under the most appropriate tension possible. This enables the quality of the sheet S to be raised.

Although not illustrated in the drawings, calibration curves expressing the relationships between the ambient temperature and the most appropriate number of revolutions are also stored in the storage section 282 for the post-cut rollers 232, the intermediate rollers 233, the first paper discharge rollers 234, and the second paper discharge rollers 235, and similar control is performed thereon to that described above.

Thus the sheet manufacturing apparatus 100 includes the temperature sensor 24 to detect temperature, and based on the detection results of the temperature sensor 24, the control section 28 adjusts the number of revolutions, namely adjusts the rotation speed, of the second roller 23B. This thereby enables the transport speed to be maintained by the second roller 23B so as to be as close as possible to the desired speed corresponding to the ambient temperature, enabling tension that is neither excessive nor insufficient to be applied to the sheet S being transported. As a result, the generation of creases in the sheet S due to slack, and a reduction in strength due to excessive tension, can both be prevented, enabling the quality of the sheet S to be raised.

The quality of the sheet S can be efficiently raised by performing the above described control on the second roller 23B that makes a comparatively high proportional contribution to the transportation of the sheet S.

As described above, the first roller 23A includes the press rollers 203 and the heating rollers 204 that are forming rollers to form the second web M8, which is a web including a material containing fiber. The sheet S can thereby be transported while being formed. This enables productivity to be raised.

Next, description follows regarding the control operation performed by the control section 28, with reference to the flowchart illustrated in FIG. 4. In the following explanation a representative example of adjustment of the rotation speed for the pre-cut rollers 231 will be described, since the adjustment of the rotation speed is similar for the pre-cut rollers 231, the post-cut rollers 232, the intermediate rollers 233, the first paper discharge rollers 234, and the second paper discharge rollers 235. Explanation follows regarding the situation prior to starting sheet manufacture.

First, the temperature is detected at step S101. Then at step S102, the correction coefficient corresponding to the temperature detected at step S101 is found using the calibration curve K1 illustrated in FIG. 5 from the detected temperature. A value resulting from adding 1 to this correction coefficient is then multiplied by the number of revolutions initially set to determine the most appropriate number of revolutions for the temperature of the atmosphere around the pre-cut rollers 231.

Then the number of revolutions determined at step S102 is executed at step S103, namely, operation is started.

Then at step S104, determination is made as to whether or not sheet S manufacture has been completed. This step is, for example, performed by determining whether or not the number of sheets S that have been manufactured has reached a pre-set number.

Processing returns to step S101 when determination is made at step S104 that the sheet S manufacture has not been completed, and the subsequent steps are repeated in sequence. Namely, in the present embodiment, the temperature is continuously detected and the most appropriate number of revolutions is re-set until the sheet S manufacture has been completed.

As described above, the sheet manufacturing apparatus 100 includes the transport section 23 to transport the sheet S made of a material containing fiber, and the control section 28 to control the operation of the transport section 23. The transport section 23 includes the first roller 23A, and the second roller 23B which is disposed downstream of the first roller 23A in the transport direction of the sheet S and separately from the first roller 23A and which is rotationally driven. The second roller 23B includes the pre-cut rollers 231, the post-cut rollers 232, the intermediate rollers 233, the first paper discharge rollers 234, and the second paper discharge rollers 235. The control section 28 adjusts the manufacturing conditions of the sheet S, and in particular adjusts the rotation speed of the second roller 23B in accordance with the temperature downstream of the first roller 23A. This thereby enables the transport speed by the second roller 23B to be maintained as close as possible to the desired speed, enabling tension neither excessive nor insufficient to be applied to the sheet S being transported. As a result, the generation of creases in the sheet S due to slack, and a reduction in strength due to excessive tension, can both be prevented, enabling the quality of the sheet S to be raised.

Note that although explanation has been given of a case in the present embodiment in which the number of revolutions is controlled in the above manner for all of the second rollers, i.e. for the pre-cut rollers 231, the post-cut rollers 232, the intermediate rollers 233, the first paper discharge rollers 234, and the second paper discharge rollers 235, the present disclosure is not limited thereto. The effects of the present disclosure may be obtained as long as the number of revolutions is controlled as described above for at least one roller type out of the pre-cut rollers 231, the post-cut rollers 232, the intermediate rollers 233, the first paper discharge rollers 234, and the second paper discharge rollers 235.

Similar correction may also be performed to at least one roller type from out of the press rollers 203, the heating rollers 204, and the tension adjustment roller 230 configuring the first roller 23A. This thereby enables the quality of the sheet S to be raised further.

### Second Embodiment

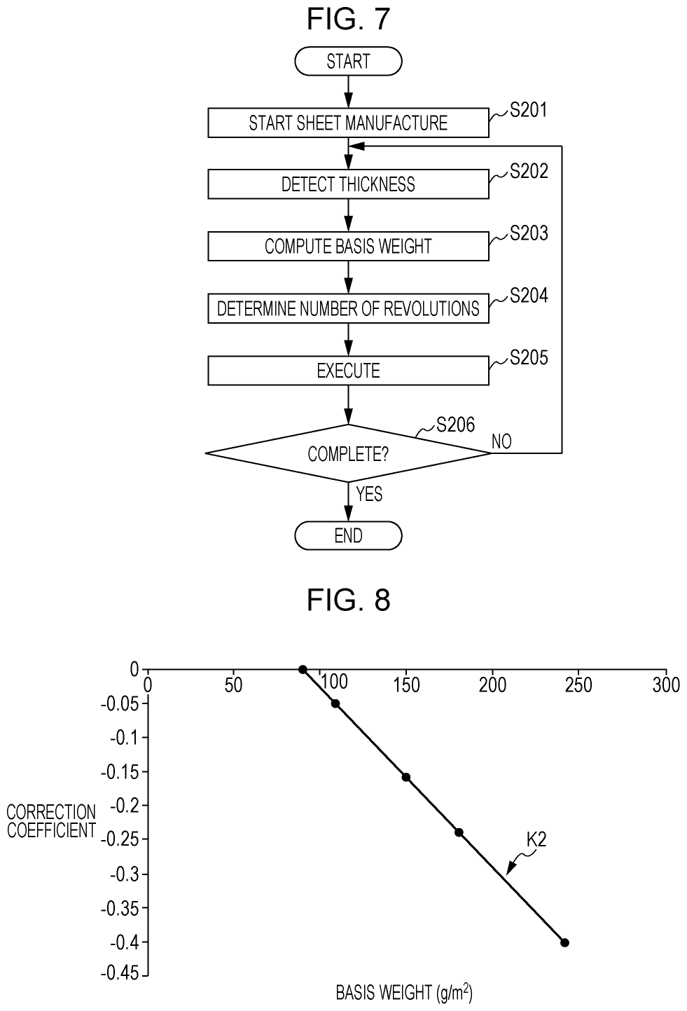

FIG. 6 is a schematic side view illustrating the downstream of a sheet manufacturing apparatus of a second embodiment of the present disclosure. FIG. 7 is a flowchart to explain a control operation performed by a control section included in the sheet manufacturing apparatus illustrated in FIG. 6. FIG. 8 is a graph illustrating a calibration curve stored in a storage section provided to the control section included in the sheet manufacturing apparatus illustrated in FIG. 6.

The following explanation regarding the sheet manufacturing apparatus of the second embodiment of the present disclosure with reference to the drawings will focus on the differences to the embodiment described above, and explanation of similar matter thereto will be omitted.

The present embodiment is similar to the first embodiment, except mainly in the control operation performed by the control section.

As illustrated in FIG. 6, in the present embodiment the sheet manufacturing apparatus 100 includes a thickness detection section 25 to detect the thickness of the sheet S. The thickness detection section 25 is installed between pre-cut rollers 231 and first cutters 211. The thickness detection section 25 may, for example, be a reflection-type optical sensor, a transmission-type optical sensor, or a contact sensor. The thickness detection section 25 is electrically coupled to the control section 28, and information related to the detected thickness is converted into an electrical signal and sent to the control section 28. The control section 28 enables, for example, a basis weight of the sheet S to be computed based on the detected thickness of the sheet S and a set feed amount (weight or density per unit area).

When applied with tension while being transported, the sheet S stretches slightly in the direction of tension. The amount of stretch is dependent on the thickness, the weight, and the density of the sheet S. Namely, the amount of stretch of the sheet S differs depending on the basis weight, with there being a greater amount of stretch for higher basis weights, and a smaller amount of stretch for lower basis weights. The actual transport speed of the sheet S varies in accordance with the proportional stretching of the sheet S. The transport speed is slower when the proportional stretching of the sheet S is larger.

Thus in the present embodiment, as illustrated in FIG. 8, a relationship between the basis weight and the correction coefficient is found in advance by experimentation, and the calibration curve K2 obtained thereby is stored in the storage section 282. The control section 28 then corrects the number of revolutions of the second roller 23B based on the calibration curve K2. This thereby enables the transport speed by the second roller 23B to be maintained as close as possible to the desired speed irrespective of the proportional stretching of the sheet S, enabling a tension neither excessive nor insufficient to be applied to the sheet S being transported. As a result, the generation of creases in the sheet S due to slack, and a reduction in strength due to excessive tension, can both be prevented, enabling the quality of the sheet S to be raised.

Note that the calibration curve K2 of FIG. 8 is a common calibration curve for all of the rollers configuring the second roller 23B.

Explanation follows regarding the control operation of the control section 28, with reference to the flowchart illustrated in FIG. 7. Note that the following explanation is about a case in which correction is performed for all of the rollers configuring the second roller 23B.

First at step S201 the manufacture of the sheet S is started. Then at the next step S202 the thickness of the sheet S is detected.

The basis weight of the sheet S is then computed at step S203. At the present step the basis weight of the sheet S is computed based on the thickness detected at step S202 and a pre-set weight or density per unit area.

Then at step S204 a correction coefficient corresponding to the computed basis weight is found from the calibration curve K2 illustrated in FIG. 8. A value resulting from adding 1 to the correction coefficient is then multiplied by the number of revolutions initially set of each roller configuring the second roller 23B to determine the most appropriate number of revolutions for all the rollers configuring the second roller 23B.

The number of revolutions determined at step S204 is then executed at step S205, namely, the numbers of revolutions are corrected for all the rollers configuring the second roller 23B.

Determination is made at step S206 as to whether or not sheet S manufacture has been completed. In the present step, for example, determination is made as to whether or not the number of sheets S that have been manufactured has reached a pre-set number.

Processing returns to step S202 when determined at step S206 that sheet S manufacture has not been completed, and the subsequent steps are repeated in sequence. Namely, in the present embodiment the temperature is continuously detected and the most appropriate number of revolutions is re-set until sheet S manufacture has been completed.

Note that although explanation has been given of a configuration in the present embodiment in which the control described above is performed based on the measured results of the thickness of the sheet S, there is no limitation thereto. For example, the thickness detection section 25 may be omitted, and the control described above performed based on a basis weight set using the operation section 26.

The control section 28 the rotation speed of the second roller 23B is thereby adjusted in accordance with a manufacturing condition of the sheet S. Moreover, the manufacturing condition of the sheet S in the present embodiment is a condition related to the thickness, the weight, or the density of the sheet S. This thereby enables the transport speed by the second roller 23B to be maintained as close as possible to the desired speed irrespective of the proportional stretching of the sheet S, enabling a tension neither excessive nor insufficient to be applied to the sheet S being transported. As a result, the generation of creases in the sheet S due to slack, and a reduction in strength due to excessive tension, can both be prevented, enabling the quality of the sheet S to be raised.

### Third Embodiment

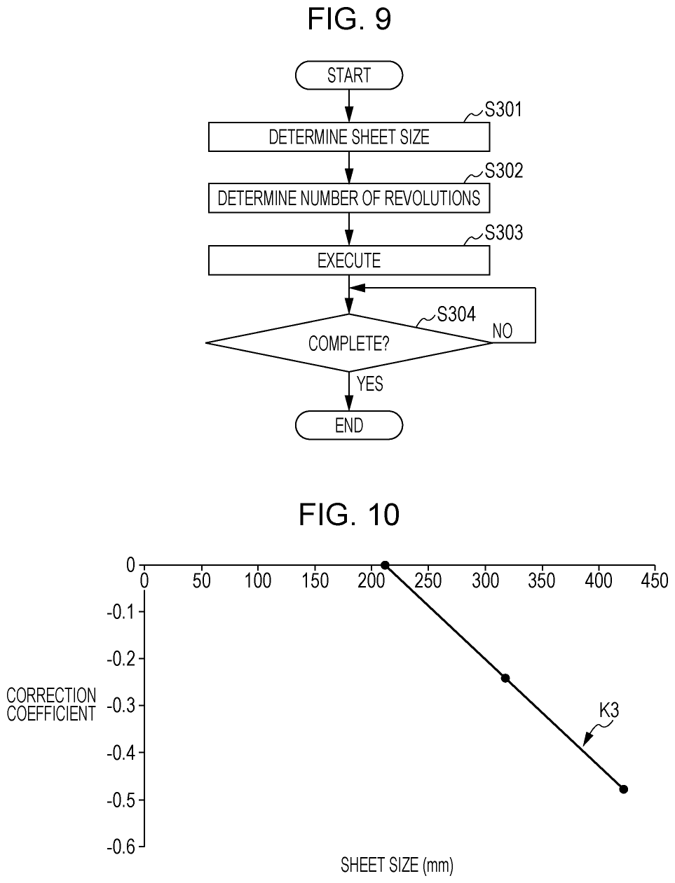

FIG. 9 is a flowchart to explain a control operation performed by a control section included in a sheet manufacturing apparatus of a third embodiment of the present disclosure. FIG. 10 is a graph illustrating a calibration curve stored in a storage section provided to a control section included in the sheet manufacturing apparatus of the third embodiment of the present disclosure.

The following explanation regarding the sheet manufacturing apparatus of the third embodiment present disclosure with reference to the drawings will focus on the differences to the embodiments described above, and explanation of similar matter thereto will be omitted.

The present embodiment is similar to the first embodiment, except mainly in the control operation performed by the control section.

For example, a one-way clutch 236 is built into the pre-cut rollers 231 illustrated in FIG. 2 and FIG. 6. The mechanical one-way clutch 236 of the pre-cut rollers 231 includes a built-in ratchet mechanism. The one-way clutch 236 prevents the pre-cut rollers 231 from reverse rotation due to the sheet S being pulled in a direction to return upstream when the sheet S has been cut by the first cutters 211.

A small amount of reverse rotation does, however, occur before the ratchet teeth of the ratchet mechanism mesh with each other. Moreover, a slight time lag arises between the ratchet teeth meshing together and rotation starting when being rotated in the normal direction.

Due to this phenomenon occurring every time cutting is performed by the first cutters 211, this phenomenon frequently occurs when there is a high frequency of cutting by the first cutters 211, namely in cases in which there is a small sheet size, and the average number of revolutions tends to be reduced to less than the desired value when considered as a whole. However, the above phenomenon occurs less frequently when there is a low frequency of cutting by the first cutters 211, namely in cases in which there is a large sheet size, and the average number of revolutions tends to rise to more than the desired value when considered as a whole.

Thus in the present embodiment, as illustrated in FIG. 10, the relationship between the size of the sheet S and the correction coefficient is found in advance by experimentation, the calibration curve K3 corresponding thereto is stored in the storage section 282, and the control section 28 corrects the number of revolutions of the pre-cut rollers 231 based on the calibration curve K3. This thereby enables the average number of revolutions of the pre-cut rollers 231 to be fixed as much as possible irrespective of the size of the sheet S, in other words irrespective of the cutting frequency. The transport speed of the pre-cut rollers 231 can thereby be maintained as close as possible to the desired speed, enabling tension that is neither excessive nor insufficient to be applied to the sheet S being transported. As a result, the generation of creases in the sheet S due to slack, and a reduction in strength due to excessive tension, can both be prevented, enabling the quality of the sheet S to be raised.

Explanation follows regarding the control operation of the control section 28, with reference to the flowchart illustrated in FIG. 9.

First, the size of the sheet S is determined at step S301. The determination at the present step is made, for example, in accordance with information from the operation section 26 illustrated in FIG. 3, i.e. in accordance with the size set by the operator using the operation section 26.

Next, at step S302, the correction coefficient corresponding to the determined size is found from the calibration curve K3 illustrated in FIG. 10. A value resulting from adding 1 to the correction coefficient is then multiplied by the number of revolutions initially set of the pre-cut rollers 231 to determine the most appropriate number of revolutions of the pre-cut rollers 231.

The number of revolutions determined at step S302 is then executed at step S303, namely sheet manufacture is started.

Next, determination is made at step S304 as to whether or not sheet S manufacture has been completed. This step is, for example, performed by determining whether or not the number of sheets S that have been manufactured has reached a pre-set number.

The control section 28 thereby adjusts the number of revolutions of the pre-cut rollers 231 in accordance with a manufacturing condition of the sheet S. The sheet S manufacturing condition in the present embodiment is a cutting condition, i.e. the cutting frequency, with which the first cutters 211 configuring the cutting section cut the sheet S. The transport speed by the pre-cut rollers 231 can thereby be maintained as close as possible to the desired speed irrespective of the size of the sheet S, thereby enabling a tension neither excessive nor insufficient to be applied to the sheet S being transported. As a result, the generation of creases in the sheet S due to slack, and a reduction in strength due to excessive tension, can both be prevented, enabling the quality of the sheet S to be raised.

Although illustrated embodiments of the sheet manufacturing apparatus of the present disclosure have been described above, the present disclosure is not limited thereto. Each of the sections configuring the sheet manufacturing apparatus may be freely replaced with configurations capable of exhibiting similar functions thereto. Additional configuration elements may also be added as desired.

The sheet manufacturing apparatus of the present disclosure may be configured by freely combining two or more configuration elements or characteristics from those described in the embodiments above.

What is claimed is:

1. A sheet manufacturing apparatus comprising:
a transport section configured to transport a sheet made of a material containing fiber; and
a control section configured to control operation of the transport section, wherein
the transport section includes a first roller and a second roller which is disposed downstream of and separately from the first roller in a transport direction of the sheet and which is rotationally driven, and
the control section is configured to adjust a rotation speed of the second roller in accordance with a manufacturing condition of the sheet.

2. The sheet manufacturing apparatus according to claim 1, wherein
the manufacturing condition of the sheet is a temperature downstream of the first roller.

3. The sheet manufacturing apparatus according to claim 2, further comprising
a temperature sensor configured to detect the temperature, wherein
the control section is configured to adjust a number of revolutions of the second roller in accordance with a detection result of the temperature sensor.

4. The sheet manufacturing apparatus according to claim 1, further comprising
a first motor driver configured to drive the first roller; and
a second motor driver configured to drive the second roller, wherein
the manufacturing condition of the sheet is a temperature of at least one of the first motor driver or the second motor driver.

5. The sheet manufacturing apparatus according to claim 1, wherein
the manufacturing condition of the sheet is a condition related to a thickness, a weight, or a density of the sheet.

6. The sheet manufacturing apparatus according to claim 1, further comprising
a cutting section configured to cut the sheet in a direction intersecting the sheet transport direction, wherein
the manufacturing condition of the sheet is a cutting condition with which the cutting section cuts the sheet.

7. The sheet manufacturing apparatus according to claim 6, wherein
the second roller includes
a pre-cut roller positioned upstream of the cutting section in the transport direction; and
a post-cut roller positioned downstream of the cutting section in the transport direction, and
the control section adjusts a number of revolutions of the pre-cut roller.

8. The sheet manufacturing apparatus according to claim 1, wherein
the second roller is adjusted to have a peripheral speed of a value greater than a value of a peripheral speed of the first roller.

9. The sheet manufacturing apparatus according to claim 1, wherein
the first roller includes a forming roller to form a web containing the material.
